(19) United States
(12) Patent Application Publication
(10) Pub. No.: US 2005/0192815 A1
(43) Pub. Date: Sep. 1, 2005

(54) Display rights management system

(76) Inventor: Stuart Macgregor Clyde, Mississauga (CA)

Correspondence Address: BERESKIN AND PARR, 40 KING STREET WEST, BOX 401, TORONTO, ON, M5H 3Y2, CA

(21) Appl. No.: 10/787,203

(22) Filed: Feb. 27, 2004

(51) Int. Cl. G06F 17/60

(52) U.S. Cl. 705/1; 705/5

(57) ABSTRACT

A method for managing the display rights for transportation means by acquiring the display rights for such transportation means from an operating company that owns or control such transportation means and then assigning them to clients who make use of them for the purposes of a display or title in exchange for a fee. The fees that are collected from a client are distributed among the various parties involved in the process of acquiring and assigning the display rights to transportation means.

### FIELD OF THE INVENTION

The present invention relates to a method and system for acquiring and then assigning the display rights for transportation means.

### BACKGROUND OF THE INVENTION

In an age where information is available in so many different forms, it is important that effective means by which to disseminate information are utilized. Those who wish to put across a message to the public are constantly in search of new opportunities and methods by which the public's attention can be captured. Therefore, the medium by which information is communicated to the public becomes extremely important as some methods will prove better able to capture the public's attention than others.

Large scale transportation means, and in particular, large aircraft and marine craft have a captivating effect on many. Their sheer size combined with their travels to different parts of the world, often give them an aura where many wish to travel or to be associated with them. It is often the case that the public will pay particular attention to an air or marine craft that comes into view.

Large scale transportation means, and in particular, air and marine craft are therefore well suited to be mediums through which information is communicated to the public. Particularly, employing the outside of these craft for purposes of displaying information will serve as a means by which to garner public attention. Irrespective of the actual form and content that the display of the information is to take, due to the attention that is paid to them, any display of information on these transportation means will provide an effective means to capture the public's eye.

Those who wish to be able to be make use of these transportation means for purposes of displaying information may not always be able to find a suitable transportation means that would serve this purpose. What is needed is a system and method that would allow for interested parties to acquire the display rights for such transportation means from a central management system whereby they would have the option of selecting from among the transportation means that are available one or more transportation means that are most suitable for them. The present invention addresses this need.

### SUMMARY OF THE INVENTION

The present invention allows for the display rights of a transportation means to be acquired by an administrator and then allows an interested party to acquire the display rights by choosing from among the various transportation means that have their display rights available for acquisition. A client will acquire the display rights for a transportation means from among the ones that are available by interacting with an agency or visiting a website which provides information as to the display rights that are available The acquisition of display rights for a transportation means allows the client to place a display or title that functions as a name on the transportation means. The fees that are collected from the client are distributed among the various parties involved in the display rights management system according to a prearranged formula.

### BRIEF DESCRIPTION OF THE DRAWINGS

FIG. 1 is a block diagram of the components of the display rights management system;

FIG. 2 is a flowchart of a display rights management system:

FIG. 3 is a flowchart of a fee distribution system; and

FIG. 4 is a block diagram of the interaction of the entities of the display rights management system interacting with a server.

### DETAILED DESCRIPTION OF THE INVENTION

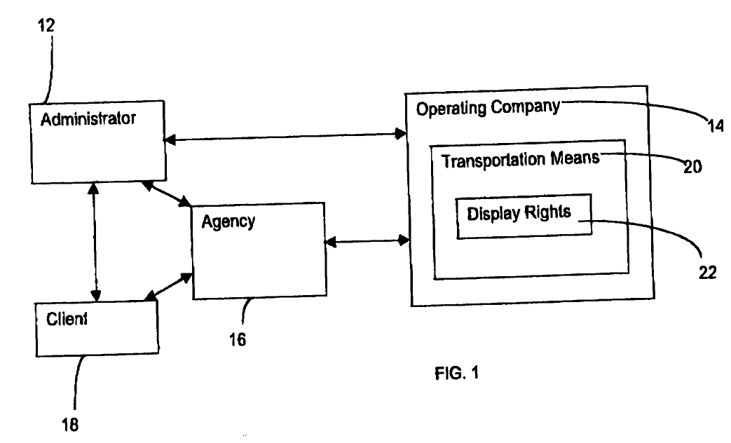

Reference is now made to FIG. 1 where a block diagram of the parties involved in a display rights management system 10 is shown. The preferred embodiment of the display rights management system 10 of the present invention comprises an administrator 12, a plurality of operating companies 14, a plurality of agencies 16 and a plurality of clients 18. Other parties or entities may also be involved in the display rights management system 10. The operating company 14 is one that owns or controls one or more transportation means 20. The display rights management system 10 involves the assignment of display right 22 for the transportation means 20 from the operating company 14 to the administrator 12 which will ultimately be assigned to the client 18. The display rights 22 give to the owner of such rights, the right to have the transportation means 20 adorned with a display or title as will be described in further detail below.

It is also envisioned that the display rights management system 10 be used for the purposes of securing and then ultimately assigning display rights 22 that may be associated with airports, seaports, train stations, space ports or for any other area which may be associated with transportation means 20. Also, it is envisioned that the display rights management system 10 may be used for the purposes of securing and ultimately assigning the display rights 22 for any buildings or structures that may have such rights associated with them in general.

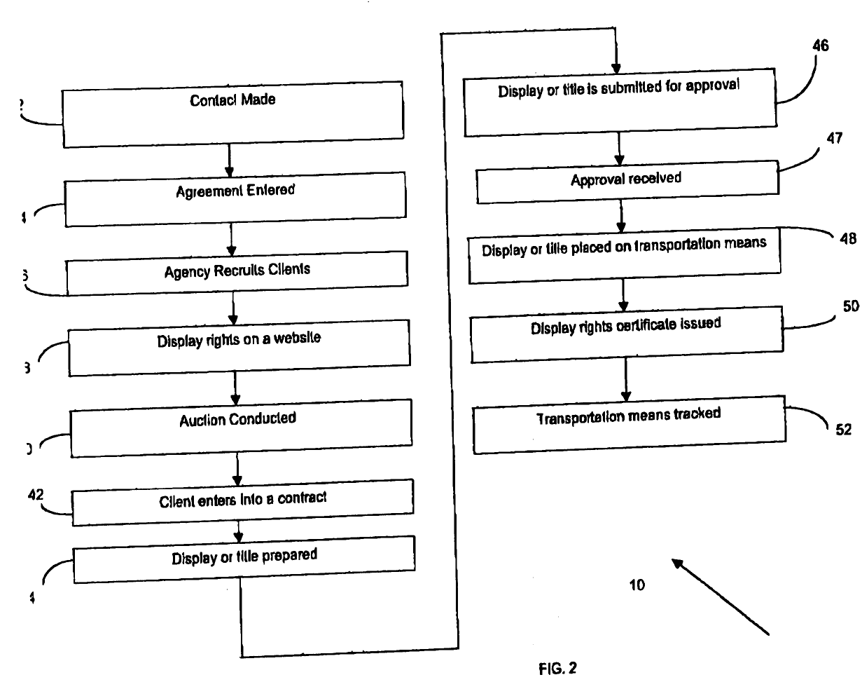

Reference is now made to FIG. 2, where a flowchart illustrating the steps involved in the display rights management system 10 is shown. Beginning at step 32 the administrator 12 of the display rights management system 10 contacts or is contacted by the operating company 14 in order for the administrator 12 to secure certain rights that are associated with their transportation means 20. The operating company 14 can be of varying types, such as for example, commercial enterprises such as airlines, cruise ships, cargo companies or railways. In the preferred embodiment, the administrator 12 will work with operating companies 14 in order to acquire the display rights 22 that are associated with the transportation means 20 they own or control. The display rights management system 10 can include any type of transportation means 20, including but not limited to transportation means for air, land, sea or rail. The display rights management system 10 requires an operating company 14 to assign the display rights 22 to an administrator 12, wherein the administrator 12 will subsequently reassign the display rights 22 to the client 18 who will make use of the display rights 22 for the purposes of a display or title. The display rights 22 will provide the rights to place a display or title on the outside of the transportation means 20. The right to place a display on the transportation means 20 allows for the use of logos, trademarks, insignias, art work, URL's (uniform resource locators) or any other combination of text or art in a manner where they will be visible on the outside of the transportation means 20.

With respect to titles, it is envisioned in the display rights management system 10 that the title that is given to the transportation means 20 will function as a way by which one can assign a name to the transportation means 20. As an example, a city that wishes to receive increased exposure, may for example, acquire display rights 22 and have the transportation means 20 adorned with the title of their choosing, which in this example may be a reference to the name of their city.

Referring back to FIG. 2, at step 32, in order to facilitate the process of the display rights 22 being assigned, the administrator 12 will contact the operating company 14 in order to attempt to negotiate and secure the display rights 22 for one or more of the transportation means 20 that the operating company 14 owns or controls. An operating company 14 who is interested in assigning the display rights 22 for one or more of the transportation means 20 that they own or control can also contact the administrator 12 themselves in order to facilitate the process.

Moving to step 34, the administrator 12 and the operating company 14 enter into an agreement with respect to the assignment of the display rights 22 from the operating company 14 to the administrator 12. The display rights 22 that are secured at this step can be of varying degrees. For example, the operating company 14 can give to the administrator 12 full and exclusive rights to all the transportation means 20 that are under their control, or temporary rights that will expire after a set period of time or any other term of rights which may be possible In the preferred embodiment, it is envisioned that display rights 22 will be of a limited duration, essentially expiring after a set number of years The display rights 22 that are received by a client 18 may essentially be for any period of time, depending on what has been agreed upon. Upon the assignment of the display rights 22 from the operating company 14 to the administrator 12, consideration is not yet exchanged in the preferred embodiment of the display rights management system 10, and will be provided to the operating company 14 at a later stage, namely when the client 18 nas had the display or title that they wish to adorn the transportation means 20 approved by the operating company 14, which will be described in further detail below. At step 34 when the assignment of the display rights 22 by the operating company 14 is made to the administrator 12, an agreement is entered into which sets out the terms and conditions that are involved in the assignment of the display rights 22. The agreement will be a binding contract between the administrator 12 and the operating company 14 setting out their respective rights and obligations. The agreement will specifically detail the terms and conditions that the parties must adhere to The agreement will contain additional provisions that will grant additional rights to the client 18 if the display rights are used for purposes of assigning a title to the transportation means 20.

An agency 16 may be used in order to attract clients who will acquire the display rights 22 that have been secured from the operating company 14 at step 36 Examples of types of agencies that can be used include a Marketing Agency, a Public Relations Agency Company, a Promotions Agency Company, and an Advertising Agency Company. It is not the intention of the inventor to restrict the term “agency” to the above list but rather it will include any entity which facilitates interaction and transaction between the administrator 12, the operating company 14 and clients 18. It is not necessary that step 36 be carried out after the display rights 22 have been secured from the operating company, as the agency 16 may already have recruited potential clients prior to the administrator 12 and the operating company 14 making contact. The display rights management system 10 can employ any number of agencies, as having multiple agencies employed will allow for prospective clients from different parts of the world to be able to interact with the agency 16 that is convenient for them with respect to location and any other factors The agency 16 will recruit clients 18 by various methods, one way of which is to place advertisements informing a targeted audience that display rights 22 for a specific transportation means 20 are available to be acquired.

The client 18 who is interested in securing the display rights 22 will be able to contact the agency 16 in order to be able to determine which display rights 22 are available to be acquired. The agency 16 who has been working in conjunction with the administrator 12 will have available to it all the information with respect to all the display rights 22 that have been secured by the administrator 12. The client 18 may also contact the agency 16 after having first been exposed to the display rights 22 that are available through advertisements placed by the agency 16. The display rights management system 10 does not require the prospective clients 18 to first interact with the agency 16 to be able to discern what display rights 22 are available for acquisition. Prospective clients 28 are also able to determine which display rights 22 are available by accessing a dedicated website at step 38.

The website will have a dedicated address and will contain information relating to the display rights 22 that are available for acquisition. Specifically, the website will list details of the specific transportation means 20, the potential cost, and the date upon which the display rights 18 will be available, and the term for which they are available, and any other terms and conditions that will apply With respect to the cost associated for acquiring the display rights 22 for a transportation means 20, in one embodiment the cost will be calculated on a yearly basis for each individual transportation means 20. The costs for display rights 22 may vary according to the operating company 14 from whom they were secured. Some operating companies 14 may command more compensation than others, primarily due to owning or controlling transportation means 20 that have greater exposure than others. The website will also allow for the viewing of all the displays or titles that are currently in use by viewing a picture of the transportation means 20 after it has been adorned with the display or title. The agency 16 or the operating company 14 may supply graphics, artwork and/or photographs of the transportation means 20, either before or after the application of a display or title to the transportation means 20 for use on the website, or for any other use the administrator 12 deems fit. Any and all information that is contained on the website, and any graphics, artwork or photographs or any other artistic display associated with the transportation means will belong to the administrator 12. The website may provide information regarding the transportation means 20 that have been adorned with a display or title, and the date upon which the current agreement for the display rights 22 for the transportation means 20 will expire. This will therefore allow the potential clients 18 who are viewing the website to be made aware of display rights 22 that are currently assigned that may become available in the future. The website will be maintained in such a way so as to always accurately reflect the various display rights 22 that are available. The website will be updated regularly so as to reflect any changes, whether they be in the form of display rights 22 being acquired by the client 18 and subsequently being unavailable for at least a period of time to others, or any display rights 22 that are acquired by the administrator 12 and hence become available to prospective clients 18. Information that would help the client 18 in determining whether or not to acquire display rights 22 such as the particulars of the transportation means 20 will be available on the website. The prospective client 18 who has visited the website will also be made aware of the list of the agencies 16 that can be contacted for further information. The agencies 16 may be listed by geographic locality, so as to make it easier for the prospective clients 18 to contact an agency 16 that is closest to them, therefore essentially allowing a prospective client 18 to be located anywhere in the world. A sample agreement that would outline what the client 18 would typically receive if they were to acquire the display rights 22 may also be found on the website.

The display rights management system 10 allows for different mechanisms to be used to allow for the client 18 to acquire the display rights 22 of the transportation means 20. The client 18 may enter into the contract with the agency 16 or the administrator 12 with respect to the display rights 22 by first participating in an auction at step 40. At step 40, the clients 18 can enter into an auction in order to attempt to secure the display rights 22 they desire. Auctions can be undertaken for all the display rights 22 whether or not the associated transportation means 20 has been commissioned into service. In one embodiment, for the display rights 22 that have been secured for transportation means 20 that have not as of yet been commissioned into service, an auction will be employed in order to allow for the prospective clients 18 to attempt to acquire the display rights 22. If an auction is conducted, it can either be a live auction or an internet based auction. The prospective clients 18 who are engaging in an auction in order to attempt to secure the display rights 22 will be able to obtain any information they require from the website or the agency 16. For the display rights 22 associated with transportation means 20 that have not been commissioned into service, the ultimate winner of the auction will have acquired the display rights 22 and will have the particular display or title that has been approved by the operating company 14 applied to the transportation means 20 before the transportation means 20 is commissioned into service. One of the terms and conditions of the agreement that was entered into between the administrator 12 and the operating company 14 is that with respect to display rights 22 for transportation means 20 that have not been commissioned into service, the display or title will be placed on the transportation means 20 before commissioning (provided that the display rights 22 are acquired by a client by this time). Also, the displays or titles that will adorn the craft will be included in any promotional materials used by the operating company 14 that relate to the new transportation means 20.

When the client 18 acquires the display rights 22 that were secured by the administrator 12, the client 18 may or may not receive the full display rights 22 that were secured by the administrator 12, depending on what the administrator 12 is willing to offer. The contract that is entered into at step 42 with respect to the acquisition of the display rights 22 by the client 18 will outline the respective rights and obligations, and terms and conditions for the parties involved. The same contract will apply to when the client 18 acquires the display rights 22 through an auction or through an agreement that they reached with the agency 16 or the administrator 12. The consideration that is to be given, if any, when it is to be given, and the rights the operating company 14 has with respect to the display or title will all be dealt with in the contract and will be discussed in further detail below.

The client 18 that has acquired the display rights 22 that are used by the client 18 for the purposes of a title will also have acquired additional rights as per the terms of the agreement between the administrator 12 and operating company 14, aside from the ones relating to having the right to place a title on the transportation means 20. Specifically, if the display rights 22 are those belonging to a commercial transportation means 20 that transports the public, such as for example an airline, cruise ship or any other transportation means 20 by which the public travel, the title that has been placed on the outside of the transportation means 20 will be publicized and used in reference to the transportation means 20 wherever possible. The operating company 14 will have agreed as per the terms of the agreement they entered into, that any transportation means 20 that have a title assigned to them will make use of the title when welcoming passengers on board. For example, an announcement can be made to the effect “Welcome aboard the spirit of Paris”, if “The Spirit of Paris” for example, was the title that was given to the transportation means 20.

Wherever possible, information in the form of photographs, pamphlets, brochures or any other informational material regarding the display or title will be made available for passengers of any commercial transportation means 20. As per the terms of the agreement between the administrator 12 and the operating company 14, the commercial transportation means 20 will carry information when appropriate with respect to the display or title.

Once the client 18 has acquired the display rights 22 by entering into an contract at step 42, at step 44 the client 18 may work in conjunction with the administrator 12 and/or the agency 16 to prepare the display or title that will ultimately adorn the transportation means 20. Once the display or title that the client 18 wishes to be placed on the transportation means 20 has been readied, the proposed display or title will be submitted to the operating company 14 at step 46 in order that it be approved by the operating company 14. The operating company 14 retains final say on the display or title, as this may entail respecting political, religious or other sensitivities and legal requirements that the client 18 may or may not be privy to. If the proposed display or title does not receive approval from the operating company 14 at step 47, the agency 16 and the client 18 will work on the proposed display or title in order that it conforms to what the operating company 14 requires.

Once a client 18 has successfully acquired the display rights 22, an advertisement will be taken out to congratulate the client 18 with respect to their successful acquisition of the display rights 22. The text of the advertisement will include details regarding the transportation means 20 and where it is likely to be seen on its various travels, and any information relating to the client 18. This advertisement will ideally be taken out in print media, preferably in localities that have a proximate relationship to the transportation means 20 and its travels. The advertisement however is not limited to print media and can be one that is placed in different mediums.

Once approval for the display or title has been received from the operating company 14 at step 47 the display or title is ready to be placed on the transportation means 20 at step 48. Also, once approval has been received from the operating company 14 at step 47, consideration that may be associated with acquiring the display rights 22 may be due. The consideration, if any, will be collected by the agency 16 from the client 18 and will be distributed among the various parties involved in a manner that is described in further detail below. With respect to the client 18 who secured the display rights 22 for the transportation means 20 that had not been commissioned into service, the display or title will have been placed on the transportation means 20 prior to commissioning. For displays or titles that have been placed on transportation means 20 prior to their commissioning, the clients 18 will have the added benefit of having their display or title receive increased exposure that may result due to any publicity the transportation means 20 may receive when it is brought into service.

After the transportation means 20 has been adorned with an acceptable display or title, a display rights certificate may be issued to the client at step 50. A display rights certificate may be created by the agency 16 or the administrator 12, and will set out the details of the transportation means 20, for example the serial number, year of manufacture, the model, place and country of manufacture, expected hours of operation per year, the route it may take on its travels and technical specifications. The display rights certificate will also include a picture of the transportation means 20 having been adorned with the display or title. The information for the display rights certificate will come from the operating company 14 who owns or controls the transportation means 20 or from research that is undertaken by the agency 16 or from any other suitable source. The display rights certificate will primarily be a promotional document, as opposed to a legal document. Along with the display rights certificate, the client 18 may also receive a scale model of the transportation means 20 that has adorned on it the respective display or title that has been chosen for it. Along with potentially receiving the display rights certificate, and a scale model, the client may also receive a photograph where the client 18 is shown with their respective transportation means 20 that has been adorned with a display or title. The display rights certificate, the scale model, and the photograph of the transportation means 20 and the client 18 may be received by the client 18 as part of a package or separately depending on the arrangement between themselves and the administrator 12 or agency 16.

The display rights management system 10 after a display or title has been placed on the transportation means 20 provides a means by which the client 18 is able to track where the transportation means 20 that has been adorned with their display or title is located at any point in time at step 52. The website which serves as a means by which the potential clients 18 are able to access information with respect to the various display rights 22 that may be available, also provides a means by which the clients 18 who have acquired the display rights 22 are able to track the location of the particular transportation means 20 at any point in time. The operating company 14 will provide to the administrator 12 or to whomever is administering the website, the arrival and departure times of the transportation means 20 on their respective journeys. The travel itinerary of the transportation means 20 for the future three to six months will also be provided by the operating company 14. If the operating company 14 makes use of internal travel tracking, such as for example is done by commercial airlines, by way of the agreement that was entered into by the administrator 12 and the operating company 14, the internal flight tracking information will be made available to the client 18 who acquires the display rights 22 by providing them with a password to access the information. This will therefore allow the client 18 the ability to track where the respective transportation means 20 that is adorned with their display or title is located. If the operating company 14 does not employ an internal flight tracking mechanism, then the operating company 14 by way of the agreement will be required to supply more generic information such as the departure time, the arrival time, departure city or port and arrival city or port of the transportation means 20 on its travels. Also, for the clients 18 that have assigned titles to the transportation means 20, when the client 18 wishes to track the movements of the transportation means 20, the client 18 will be able to search for the location information with respect to this transportation means 20 by inputting the title into a field that will allow them to browse the respective travel records. Regardless of the information the client 18 is accessing, and regardless of whether it is being accessed by reference to titles, a password may be provided to the client 18 to ensure only that appropriate parties are accessing the information that would allow for tracking of the transportation means 20.

Any obligation that the administrator 12 requires any entity to fulfill, whether it be the operating company 14, the agency 16, or the client 18, may be taken over by the administrator 12 as the administrator 12 deems fit as per the terms of the agreement that the administrator 12 entered into with any of the above mentioned parties. For example, as has been stated above, with respect to the operating company 14 or agency 16 who may be responsible for providing any graphics, art work or photographs of the transportation means 20 for use on the website, the administrator 12 at their discretion may relieve the operating company 14 and the agency 16 of these obligations.

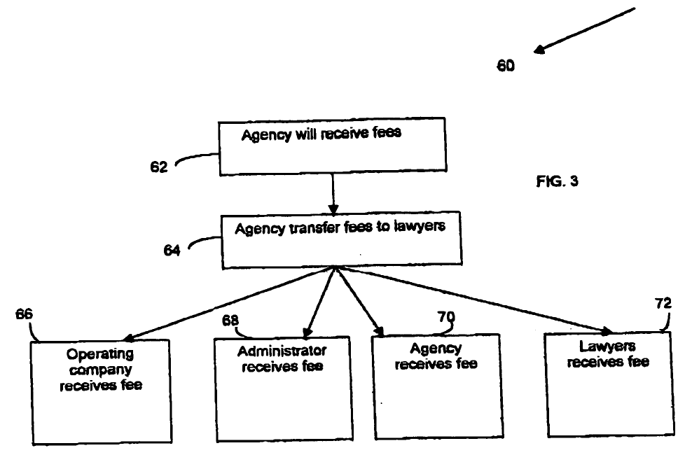

Referring now to FIG. 3, a flowchart detailing a consideration distribution system shown generally as 60 is shown. System 60 comprises a plurality of components. It is envisioned that the display rights management system 10 can be used for non-profit purposes as well, and display rights 22 may also be assigned to entities at no charge. Beginning at step 62 if a fee is paid for the acquisition of the display rights, it will be transferred from the client 18 to the agency 16. Fees are one example of the type of consideration that may be received. It is however, not necessary that the client 18 submit the fees, if any have been paid, to the agency 16, as it is possible that they pay them directly to a second or third party who will be responsible for distributing the fees. As an example, the second or third party may for example be lawyers or accountants The fees, if any are received by the agency 16 for the display rights 22 from the client 18, may be shared among different parties. In system 60 the various parties involved have agreed on a means by which to share the proceeds from the assignment of the display rights 22. The respected parties may have agreed to receive a flat fee or a percentage of the fees. It is also envisioned that consideration can be provided based on a variable percentage fee basis where the percentage fee is not fixed and will be determined based on an incentive based system at the discretion of the administrator 12. The fees that are received by the agency 16 will then be transferred in their entirety to the second or third party at step 64. With respect to the second or third party to whom the fees that may have been received are transferred to, it is envisioned that lawyers or accountants or any other suitable individual or organization be employed in order to carry out this role. In one embodiment of the consideration distribution system 60, with respect to any fees that may have been received, certain parties will receive compensation based on a flat fee and certain parties will receive compensation based on a percentage fee basis. The second or third party will receive a flat fee for any work they are to perform. The second or third party will be in the employ of the administrator 12 and will be responsible for distributing the fees in their appropriate shares or amounts to the respective parties involved in the display rights management system 10. The payment that is made by the second or third party to the operating company 14 at step 66 is a percentage fee Payments that are made by the second or third party to the administrator 12 at step 68 will be made on a percentage fee basis. The payments that are made by the second or third party to the agency 16 at step 70 are made on a percentage fee basis. The payment that is made to the administrator 12, operating company 14 or agency 16 can also involve elements of being a combination of a flat fee and a percentage fee with the potential for an additional payment to be based on a variable incentive scheme through a variable percentage fee. One example of a proposed share to be received by the involved parties where fees have been received is the following, the administrator 12 will receive 35% of the fees received from the client 18, the operating company 14 will receive 20%, the agency 16 will receive 15% and the remaining 30% that has not been distributed will be used in order to cover any administrative costs that may be involved, as well as paying the flat fee that is to be paid to the second or third party at step 72. These are just examples that have been mentioned, where in it is possible to have variables of these percentages as this will be based on negotiations between the respective parties.

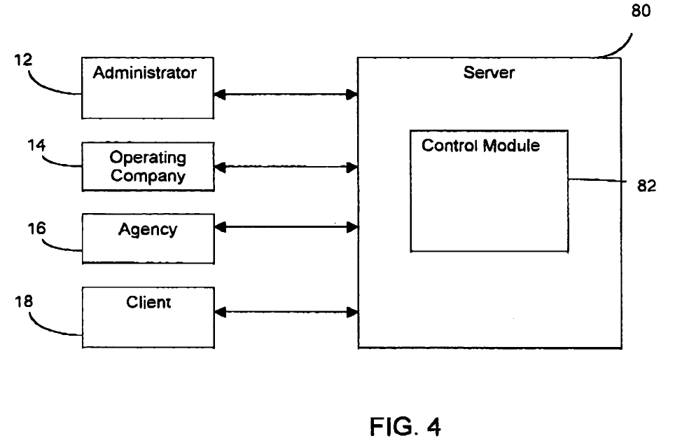

Referring now to FIG. 4, the display rights management system 10 is shown with respect to the interaction of the various entities and a server 80 and control module 82. The server 80 of the display rights management system 10 contains the control module 82 which may be used to operate the website. The administrator 12 may interact with the server 80 in order to maintain and access information relating to the display rights 22 of the transportation means 20. The operating company 14 may interact with the server 80 with respect to accessing information with respect to the transportation means 20 that are part of the display rights management system 10. The operating company 14 may also interact with the server when providing information relating to the itinerary of the transportation means 20. The agency 16 may interact with the server with respect to maintaining and accessing information relating to transportation means 20 and the display rights 22 associated with those transportation means 20. The client 18 may interact with the server 80 in order to access information with respect to the transportation means 20 that are part of the display rights management system 10 which may have their display rights 22 available for acquisition, as well as for potentially engaging in an auction that may be used in order to attempt to assign display rights 22 to clients 18. Clients 18 may also interact with the server 80 when tracking the location of transportation means 20.

It should be understood that various changes may be made to the embodiments of the invention described herein without departing from the subject invention, the scope of which is defined in the following claims.

1. A method for managing display rights for transportation means, the method comprising the steps of:
a) acquiring said display rights for said transportation means from an operating company:
b) assigning said display rights to a client; and
c) distributing any compensation from said client for said display rights.

2. The method of claim 1, wherein acquiring said display rights further comprises the right to place a display on said transportation means.

3. The method of claim 1, wherein acquiring said display rights further comprises the right to place a title on said transportation means.

4. The method of claim 1, wherein said display rights may be viewed on a website.

5. The method of claim 1, wherein said display rights may be assigned by auction.

6. The method of claim 1, further comprising the steps of
a) receiving a travel itinerary from an operating company:
b) maintaining a website containing said travel itinerary; and
c) allowing client access to said travel itinerary to track said transportation means.

7. The method of claim 1, further comprising the steps of
a) receiving consideration from a client who acquired said display rights; and
b) distributing said consideration.
